(19) United States
(12) Patent Application Publication
(10) Pub. No.: US 2026/0185726 A1
(43) Pub. Date: Jul. 2, 2026

(54) AIR CONDITIONER AND METHOD FOR OPERATING SAME

(71) Applicant: LG ELECTRONICS INC., Seoul (KR)

(72) Inventors: Kyuyeol SHIN, Seoul (KR); Donghyeon KIM, Seoul (KR); Jaeho LEE, Seoul (KR); Gahyeon SONG, Seoul (KR)

(73) Assignee: LG ELECTRONICS INC., Seoul (KR)

(21) Appl. No.: 19/080,515

(22) Filed: Mar. 14, 2025

(30) Foreign Application Priority Data
Dec. 31, 2024 (KR) 10-2024-0202824

(51) Int. Cl. F24F 11/32; F28G 9/00; F28G 15/00

(52) U.S. Cl. CPC F24F 11/32; F28G 9/00; F28G 15/003

(57) ABSTRACT

A method for operating an air conditioner having a compressor that compresses and discharges a refrigerant and an indoor heat exchanger that exchanges heat between the refrigerant and indoor air includes accumulating a contamination index of the indoor heat exchanger using indoor humidity and a temperature of the indoor heat exchanger as factors, comparing the accumulated contamination index with a first reference contamination index, and when the accumulated contamination index is equal to or greater than the first reference contamination index, performing a heat exchanger cleaning process. An air conditioner implementing the method is also provided.

### CROSS-REFERENCE TO RELATED APPLICATIONS

This non-provisional application claims the benefit under 35 U.S.C. § 119 (a) to Patent Application No. 10-2024-0202824, filed in the Republic of Korea on Dec. 31, 2024, all of which is hereby expressly incorporated by reference into the present application.

### BACKGROUND

The present disclosure relates to an air conditioner and a method for operating the same, and more particularly, to an air conditioner capable of removing foreign substances adsorbed on an indoor heat exchanger and a method for operating the same.

Air conditioners are installed to provide a more comfortable indoor environment for people by discharging hot and cold air into the room to control the indoor temperature and purify the indoor air in order to create a comfortable indoor environment. In general, air conditioners include an indoor part that is installed indoors and is composed of a heat exchanger, and an outdoor part that is composed of a compressor, a heat exchanger, and the like and supplies refrigerant to the indoor part.

The air conditioner operates in cooling or heating mode according to the flow of the refrigerant. For example, during cooling mode, high-temperature, high-pressure liquid refrigerant that has passed through the outdoor part's heat exchanger from the outdoor part's compressor is supplied to the indoor part, and cold air is formed as the refrigerant expands and vaporizes in the indoor part's heat exchanger, and the cold air is supplied to the indoors as the indoor part's fan rotates. On the other hand, during heating mode, high-temperature, high-pressure gaseous refrigerant is supplied to the indoor part from the outdoor part's compressor, and air warmed by the energy released as the high-temperature, high-pressure gaseous refrigerant liquefies in the indoor part's heat exchanger is supplied to the indoors as the indoor part's fan operates.

During the operation of the air conditioner, foreign substances such as dust may be adsorbed on the heat exchanger of the indoor part. For example, during the cooling operation of the air conditioner, condensate may be generated in the heat exchanger of the indoor part through heat exchange between the refrigerant and indoor air. At this time, if some of the condensate forms on the surface of the heat exchanger of the indoor part or remains in the drain pipe through which the condensate is discharged, foreign substances may be absorbed into the condensate.

In this way, if foreign substances are adsorbed on the heat exchanger of the indoor part, the foreign substances can cause microorganisms such as bacteria and mold to multiply, which can increase the level of contamination. In this case, not only can it cause discomfort to the user, but it can also have a detrimental effect on the user's health, so various studies are being conducted on cleaning the heat exchanger of the indoor part to remove foreign substances adsorbed on the heat exchanger of the indoor part and reduce the level of contamination.

In order to remove foreign substances adsorbed on the heat exchanger of an indoor part, a conventional air conditioner performs a defrosting operation to form frost on the surface of the heat exchanger of the indoor part using a refrigerant cycle and then remove the frost formed on the surface of the heat exchanger, as in Prior Art 1 (Japanese Patent Publication No. 2010-014288). At this time, as the water formed on the surface of the heat exchanger by the defrosting operation flows and is drained, foreign substances adsorbed on the heat exchanger of the indoor part can be removed together with the water.

In addition, conventional air conditioners can operate so that water droplets first condense on the surface of the heat exchanger before forming frost on the surface of the heat exchanger of the indoor part, as in Prior Art 2 (Japanese Patent Publication No. 2018-200128), thereby allowing a larger amount of water to be drained when removing foreign substances.

Meanwhile, it may be desirable to clean the indoor part's heat exchanger when the contamination level is equal to or greater than a certain reference value in terms of energy efficiency. Therefore, the air conditioner needs to measure the contamination level of the indoor part's heat exchanger in real time. However, there are technical difficulties in directly measuring the contamination level of the indoor part's heat exchanger.

### SUMMARY

An object of an embodiment of the present disclosure is to provide an air conditioner capable of efficiently reducing the contamination level of an indoor heat exchanger, and a method for operating the same.

An object of an embodiment of the present disclosure is to provide an air conditioner capable of predicting the contamination level of an indoor heat exchanger using a predictive model derived from big data-based machine learning and informing a user of the expected contamination status of the heat exchange, and a method for operating the same.

An object of an embodiment of the present disclosure is to provide an air conditioner capable of efficiently managing the contamination level of an indoor heat exchanger by predicting the contamination level of an indoor heat exchanger using a predictive model derived from big data-based machine learning and performing indoor heat exchanger cleaning, and a method for operating the same.

A method for operating an air conditioner according to one embodiment for solving the task including a compressor that compresses and discharges a refrigerant, and an indoor heat exchanger that heat-exchanges the refrigerant and indoor air, the method includes a step of accumulating a contamination index of the indoor heat exchanger using indoor humidity and a temperature of the indoor heat exchanger as factors; and a step of comparing the accumulated contamination index with a first reference contamination index, and in which if the accumulated contamination index is equal to or greater than the first reference contamination index, the heat exchanger cleaning process is performed.

If the accumulated contamination index is lower than the first reference contamination index, the method may return to the step of accumulating the contamination index of the indoor heat exchanger.

If the accumulated contamination index is equal to or greater than the first reference contamination index, before the heat exchanger cleaning process, a step of determining whether a condition for performing the heat exchanger cleaning process is satisfied may be performed, If the condition for performing the heat exchanger cleaning process is satisfied, the heat exchanger cleaning process may be performed, and if the condition for performing the heat exchanger cleaning process is not satisfied, the method may return to the step of accumulating the contamination index of the indoor heat exchanger.

Prior to the step of determining whether a condition for performing the heat exchanger cleaning process is satisfied, a cleaning notification step may be performed to inform a user that the heat exchanger cleaning process is required.

The cleaning notification step may display on a display part that is provided in the air conditioner and displays a status of the indoor heat exchanger that the heat exchanger cleaning process is required, or display on the user's remote device that the heat exchanger cleaning process is required.

The step of determining whether a condition for performing the heat exchanger cleaning process is satisfied may determine whether the indoor temperature of a space where the indoor heat exchanger is disposed and an outdoor temperature outside the space fall within a reference temperature range.

When the heat exchanger cleaning process is finished, a step of determining whether the heat exchanger cleaning process is completed may be performed, and if the heat exchanger cleaning process is completed and finished, a step of initializing the accumulated contamination index may be performed, and if the heat exchanger cleaning process is finished without being completed, the method may return to the step of comparing the accumulated contamination index with the first reference contamination index.

When the heat exchanger cleaning process is finished, a step of determining whether the heat exchanger cleaning process may be finished is performed, if the heat exchanger cleaning process is completed and finished, a step of counting the number of repetitions of the heat exchanger cleaning process; and a step of resetting the accumulated contamination index may be performed, and in the step of resetting the accumulated contamination index, as the number of repetitions of the heat exchanger cleaning process increases, a reset value of the accumulated contamination index may increase.

When the heat exchanger cleaning process is finished, a step of determining whether the heat exchanger cleaning process is finished may be performed, if the heat exchanger cleaning process is completed and finished, a step of counting the number of repetitions of the heat exchanger cleaning process and a step of resetting the first reference contamination index may be performed, and in the step of resetting the first reference contamination index, as the number of repetitions of the heat exchanger cleaning process increases, a reset value of the first reference contamination index may decrease.

If the heat exchanger cleaning process is finished without being completed, the method may return to the step of comparing the accumulated contamination index with the first reference contamination index.

If the accumulated contamination index is equal to or greater than the first reference contamination index, a step of determining whether a condition for performing the heat exchanger cleaning process is satisfied may be performed, if the condition for performing the heat exchanger cleaning process is satisfied, the heat exchanger cleaning process may be performed, and if the condition for performing the heat exchanger cleaning process is not satisfied, a step of comparing the accumulated contamination index with a second reference contamination index may be performed, and in the step of comparing the accumulated contamination index with the second reference contamination index, if the accumulated contamination index is equal to or greater than the second reference contamination index, a cleaning service recommendation notification step may be performed to notify a user that a cleaning service is required, and if the accumulated contamination index is less than the second reference contamination index, the method may return the step of accumulating the contamination index of the indoor heat exchanger.

The heat exchanger cleaning process may include a step of condensing water on a surface of the indoor heat exchanger; a step of freezing the condensed water; and a step of drying the surface of the indoor heat exchanger.

An air conditioner according to one embodiment for solving the task includes a compressor for compressing and discharging a refrigerant; an indoor heat exchanger for heat-exchanging the refrigerant and indoor air; and a controller for controlling a heat exchanger cleaning process for cleaning the indoor heat exchanger, in which the controller performs a step of accumulating a contamination index of the indoor heat exchanger using indoor humidity and a temperature of the indoor heat exchanger as factors; and a step of comparing the accumulated contamination index with a first reference contamination index, and if the accumulated contamination index is equal to or greater than the first reference contamination index, the controller may perform the heat exchanger cleaning process.

If the accumulated contamination index is less than the first reference contamination index, the controller may return to the step of accumulating the contamination index of the indoor heat exchanger.

If the accumulated contamination index is equal to or greater than the first reference contamination index, the controller may perform a step of determining whether a condition for performing the heat exchanger cleaning process is satisfied before the heat exchanger cleaning process, if the condition for performing the heat exchanger cleaning process is satisfied, the controller may perform the heat exchanger cleaning process, and if the condition for performing the heat exchanger cleaning process is not satisfied, the controller may return to the step of accumulating the contamination index of the indoor heat exchanger.

The air conditioner may further include a display part that displays a status of the indoor heat exchanger, in which the controller may perform a cleaning notification step that notifies a user that the heat exchanger cleaning process is required before the step of determining whether a condition for performing the heat exchanger cleaning process is satisfied, and the cleaning notification step may display on the display part that the heat exchanger cleaning process is required, or display on the user's remote device that the heat exchanger cleaning process is required.

The step of determining whether a condition for performing the heat exchanger cleaning process is satisfied before the heat exchanger cleaning process may determine whether the indoor temperature of the space where the indoor heat exchanger is disposed and the outdoor temperature outside the space fall within a reference temperature range.

When the heat exchanger cleaning process is finished, the controller may perform a step of determining whether the heat exchanger cleaning process is completed, and if the heat exchanger cleaning process is completed and finished, the controller may perform a step of initializing the accumulated contamination index, and if the heat exchanger cleaning process is finished without being completed, the controller may return to the step of comparing the accumulated contamination index with the first reference contamination index.

When the heat exchanger cleaning process is finished, the controller may perform a step of determining whether the heat exchanger cleaning process is completed, if the heat exchanger cleaning process is completed and finished, the controller may perform a step of counting the number of times the heat exchanger cleaning process is repeated and a step of resetting the accumulated contamination index, and in the step of resetting the accumulated contamination index, as the number of repetitions of the above heat exchanger cleaning process increases, a reset value of the above accumulated contamination index may increase.

When the heat exchanger cleaning process is finished, the controller may perform a step of determining whether the heat exchanger cleaning process is completed, if the heat exchanger cleaning process is completed and finished, the controller may perform a step of counting the number of repetitions of the heat exchanger cleaning process and a step of resetting the first reference contamination index, and in the step of resetting the first reference contamination index, as the number of repetitions of the heat exchanger cleaning process increases, a reset value of the first reference contamination index may decrease, and if the heat exchanger cleaning process is finished without being completed, the controller may return to the step of comparing the accumulated contamination index with the first reference contamination index.

According to an embodiment of the present disclosure, the contamination level of an indoor heat exchanger can be efficiently reduced.

According to an embodiment of the present disclosure, the contamination level of an indoor heat exchanger can be predicted using a prediction model calculated from big data-based machine learning, thereby informing a user of the expected contamination status of the heat exchanger.

According to an embodiment of the present disclosure, the contamination level of an indoor heat exchanger can be efficiently managed by predicting the contamination level of an indoor heat exchanger through a prediction model calculated through big data-based machine learning and performing indoor heat exchanger cleaning.

### BRIEF DESCRIPTION OF THE DRAWINGS

FIG. 1 is a view illustrating the configuration of an air conditioner according to one embodiment.

FIG. 2 is a schematic diagram illustrating an outdoor part and an indoor part according to one embodiment.

FIG. 3 is a block diagram illustrating an air conditioner according to one embodiment.

FIG. 4 is a flowchart illustrating an method for operating an air conditioner according to one embodiment.

FIG. 5 is a contamination index table for accumulating the contamination index of an indoor heat exchanger of an air conditioner according to one embodiment.

FIG. 6 is a flowchart illustrating a cleaning process of an indoor heat exchanger in an air conditioner according to one embodiment.

FIG. 7 is a view illustrating an example of the contamination level of an indoor heat exchanger of an air conditioner according to one embodiment.

FIG. 8 is a view illustrating an example of a display part of an air conditioner according to one embodiment indicating the status of a heat exchanger.

FIG. 9 is a view illustrating an example of a display part of an air conditioner according to one embodiment indicating the status of a heat exchanger cleaning operation.

FIGS. 10 and 11 are views illustrating an example of a screen of a remote device capable of controlling a method for operating an air conditioner according to one embodiment.

FIG. 12 is a flowchart illustrating a method for operating an air conditioner according to another embodiment.

FIG. 13 is a flowchart illustrating a method for operating an air conditioner according to another embodiment.

FIG. 14 is flowchart illustrating a method for operating an air conditioner according to another embodiment.

FIG. 15 is a view illustrating the configuration of an air conditioner according to another embodiment including a plurality of indoor parts.

### DETAILED DESCRIPTION OF THE EMBODIMENTS

Hereinafter, specific embodiments of the present disclosure will be described in detail with reference to the drawings. However, the present disclosure is not limited to the embodiments in which the idea of the present disclosure is presented, and other regressive disclosures or other embodiments included within the scope of the idea of the present disclosure can be easily proposed by adding of other components, changing, deleting, or the like.

In order to clearly and briefly explain the present disclosure, parts irrelevant to the description are omitted in the drawings, and the same drawing reference numerals are used for identical or extremely similar parts throughout the specification.

The suffixes “module” and “part” used for components in the following description are given simply for the convenience of writing this specification, and do not in themselves impart any particularly important meaning or role. Accordingly, the “module” and “part” may be used interchangeably.

In this specification, it should be understood that the terms “comprises,” “has,” or the like are intended to specify the presence of a feature, number, step, operation, component, part, or combination thereof described in the specification, but do not exclude in advance the possibility of the presence or addition of one or more other features, numbers, steps, operations, components, parts, or combinations thereof.

Additionally, in this specification, terms such as first, second, etc. may be used to describe various elements, but these elements are not limited by these terms. These terms are only used to distinguish one element from another.

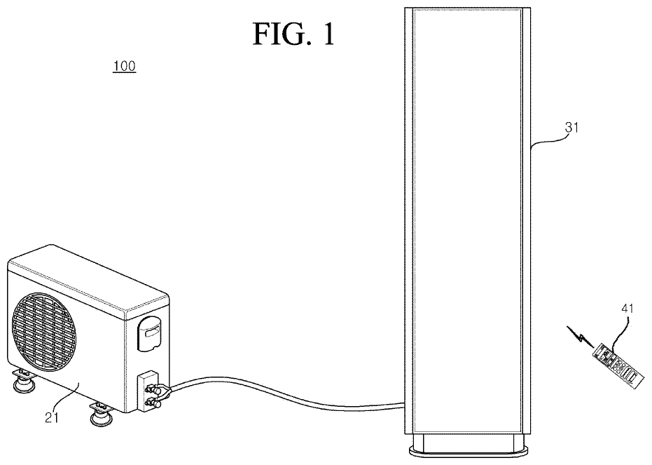

FIG. 1 is a view illustrating the configuration of an air conditioner according to one embodiment.

Referring to FIG. 1, an air conditioner 100 according to one embodiment may include an outdoor part 21 and an indoor part 31 connected to the outdoor part 21. In FIG. 1, a stand-alone indoor part 31 is exemplified as the indoor part 31, but the present disclosure is not limited thereto and the indoor part 31 may be applied to other types of indoor parts such as a wall-mounted indoor part and a ceiling-mounted indoor part.

An air conditioner 100 according to one embodiment may further include a remote device 41 that is provided to control the outdoor part 21 and the indoor part 31. In other words, a user may control the operation of the air conditioner 100 through the remote device 41. For example, the remote device 41 may be a dedicated remote control for the air conditioner 100, but is not limited thereto and may be a terminal device such as a smart phone on which an application capable of controlling the air conditioner 100 is installed.

In addition, the air conditioner 100 according to one embodiment may further include at least one of a ventilation device, an air purifier, a humidifier, and a heater configured to operate in conjunction with the operations of the indoor part 31 and the outdoor part 21.

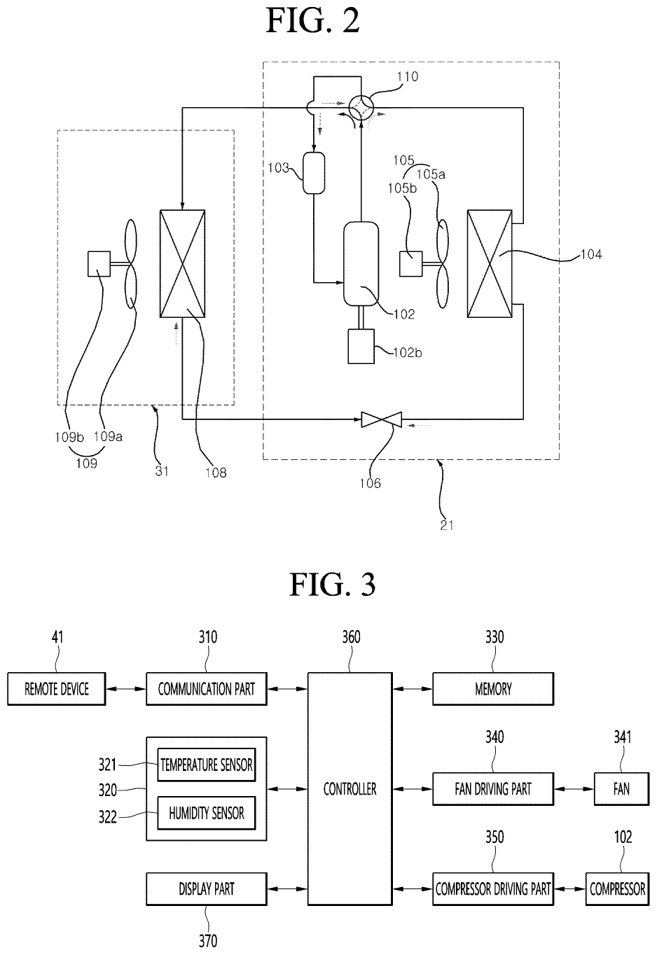

The outdoor part 21 operates the equipped compressor 102 (in FIG. 2) to compress the refrigerant according to the setting and supply the refrigerant to the indoor part 31. The outdoor part 21 can be driven by a request from a remote device 41 or an indoor part 31. At this time, as the cooling/heating capacity varies in response to the driven indoor part 31, the number of operating outdoor parts 21 and the number of operating compressors 102 installed in the outdoor part 21 may vary.

The indoor part 31 receives refrigerant from the outdoor part 21. The indoor part 31 supplies air that has exchanged heat with the supplied refrigerant to the indoors.

The outdoor part 21 and the indoor part 31 transmit and receive data. For example, the outdoor part 21 and the indoor part 31 can be connected to a communication line and transmit and receive data. In addition, the outdoor part 21 and the indoor part 31 can be connected to a remote device 41 by wire or wirelessly and operate under the control of the remote device 41. In addition, the outdoor part 21 and the indoor part 31 can be connected to a management server by wire or wirelessly and transmit and receive data.

The detailed structures of the outdoor part 21 and indoor part 31 will be described later with reference to FIG. 2.

FIG. 2 is a schematic diagram illustrating an outdoor part and an indoor part according to one embodiment.

Referring to FIG. 2, an outdoor part 21 of an air conditioner 100 according to one embodiment may include a compressor 102 that compresses refrigerant, an outdoor heat exchanger 104 that dissipates heat from the compressed refrigerant, an outdoor blower 105 that is disposed on one side of the outdoor heat exchanger 104 to promote heat dissipation from the refrigerant, an expansion valve 106 that expands condensed refrigerant, and a cooling/heating switching valve 110 that changes the flow path of the compressed refrigerant.

Meanwhile, the outdoor part 21 of the air conditioner 100 according to one embodiment may further include a compressor motor 102b that drives the compressor 102 and an accumulator 103 that temporarily stores the vaporized refrigerant to remove moisture and foreign substances and then supplies the refrigerant at a constant pressure to the compressor 102.

Additionally, the outdoor blower 105 according to one embodiment may include an outdoor fan 105a that forms a flow of air through rotation and a motor 105b that rotates the outdoor fan 105a.

For example, the expansion valve 106 may be an electronic expansion valve (EEV).

An indoor part 31 of an air conditioner 100 according to one embodiment may include an indoor heat exchanger 108 that is disposed indoors and performs a cooling/heating function, and an indoor blower 109 that is disposed on one side of the indoor heat exchanger 108 and promotes heat dissipation of a refrigerant. As an example, the indoor blower 109 may include an indoor fan 109a that forms an air flow through rotation, and a motor 109b that rotates the indoor fan 109a.

The indoor part 31 of the air conditioner 100 according to one embodiment may include at least one indoor heat exchanger 108. In this specification, the heat exchanger 108 of the indoor part 31 and the indoor heat exchanger 108 may be understood to refer to the same configuration. Meanwhile, the compressor 102 may use at least one of an inverter compressor and a constant-speed compressor.

Additionally, the air conditioner 100 may be configured as a cooler for cooling a room, or as a heat pump for cooling or heating a room.

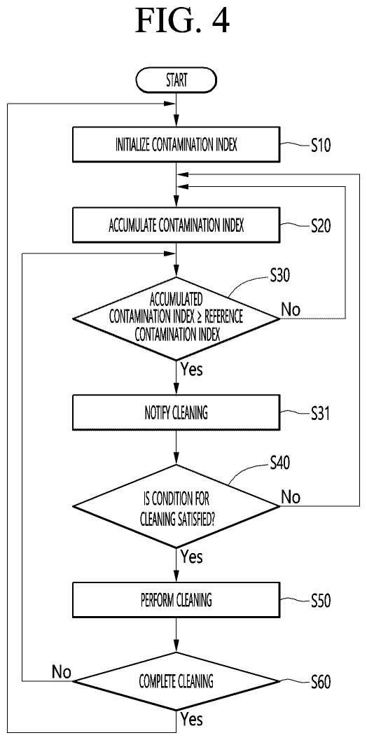

FIG. 3 is a block diagram illustrating an air conditioner according to one embodiment.

Referring to FIG. 3, an air conditioner 100 according to one embodiment may include a communication part 310, a sensor part 320, a memory 330, a fan driving part 340 that drives a fan 341, a compressor driving part 350 that drives a compressor 102, a controller 360, and a display part 370.

The communication part 310 may include at least one communication module. For example, the communication part 310 may be provided in each of the outdoor part 21 and the indoor part 31. The outdoor part 21 and the indoor part 31 may transmit and receive data to and from each other through the communication part 310 provided therein. For example, the communication method between the outdoor part 21 and the indoor part 31 may be a communication method using a power line, a serial communication method (for example, RS-485 communication), a wired communication method through a refrigerant pipe, and a wireless communication method such as Wi-fi, Bluetooth, Beacon, or Zigbee.

The communication part 310 may be configured to transmit and receive data with an external device. For example, the communication part 310 may connect to a remote device 41 or a management server connected to an external network to transmit and receive data.

The sensor part 320 may be equipped with at least one sensor. The sensor part 320 may transmit data on a measurement value measured through the sensor to the controller 360.

In addition, the sensor part 320 may include a pressure sensor configured to measure the pressure of the gaseous refrigerant flowing through each pipe of the air conditioner 100. For example, the pressure sensor may be disposed in a pipe connected to the compressor 102 to measure the pressure of the refrigerant flowing into the compressor 102 (hereinafter, suction pressure) and/or the pressure of the refrigerant discharged from the compressor 102 (hereinafter, discharge pressure).

In addition, the sensor part 320 may include a temperature sensor 321 that measures temperature. The temperature sensor 321 may include an indoor temperature sensor that measures the temperature of an indoor space where the indoor part 31 is disposed, an outdoor temperature sensor that measures the temperature of an outdoor space where the outdoor part 21 is disposed, a heat exchanger temperature sensor that is disposed inside the indoor heat exchanger 108 and configured to measure the temperature of the indoor heat exchanger 108, and a pipe temperature sensor that is configured to measure the temperature of refrigerant flowing through each pipe of the air conditioner 100.

The pipe temperature sensor is disposed in the pipe on the inlet side of the indoor part 31 and/or the pipe on the outlet side of the indoor part 31 and can measure the temperature of the refrigerant flowing through the pipe. For example, the pipe temperature sensor is disposed in the pipe connected to the compressor 102 and can measure the temperature of the refrigerant flowing into the compressor 102 (hereinafter, suction temperature) and/or the temperature of the refrigerant discharged from the compressor 102 (hereinafter, discharge temperature).

In addition, the sensor part 320 may include a humidity sensor 322 that measures humidity. The humidity sensor 322 may include an indoor humidity sensor that measures humidity in the room where the indoor part 31 is disposed and an outdoor humidity sensor that measures humidity in the outdoors where the outdoor part 21 is disposed.

An air conditioner 100 according to one embodiment can predict the contamination level of an indoor heat exchanger 108 by measuring the temperature of the indoor heat exchanger 108 through the heat exchanger temperature sensor and the indoor humidity measured through the humidity sensor. As will be described later, the contamination level prediction of the indoor heat exchanger 108 can be performed through the controller 360.

Accordingly, in this specification, the temperature sensor 321 may refer to the heat exchanger temperature sensor that measures the temperature of the indoor heat exchanger 108, and the humidity sensor 322 may refer to the indoor humidity sensor that measures the humidity in the room. In addition, the indoor temperature and indoor humidity may be values measured and received from a device separate from the air conditioner 100 or may use predicted values.

The memory 330 of the air conditioner 100 according to one embodiment can store data on reference values related to the operation of each component provided in the air conditioner 100.

The memory 330 can store programs for each signal processing and control within the controller 360. The memory 330 can store processed data and data to be processed. For example, the memory 330 can store application programs designed for the purpose of performing various tasks that can be processed by the controller 360, and can selectively provide some of the stored application programs upon request from the controller 360.

For example, the memory 330 may include at least one of volatile memory (for example, DRAM, SRAM, SDRAM, or the like) or non-volatile memory (for example, flash memory, hard disk drive (HDD), solid-state drive (SSD), or the like).

The fan driving part 340 can drive a fan 341 provided in the air conditioner 100. For example, the fan 341 can include an outdoor fan 105a and an indoor fan 109a.

The fan driving part 340 may include a rectifier that rectifies AC power into DC power and outputs it, a DC-link capacitor that stores a pulsating voltage from the rectifier, an inverter that has a plurality of switching elements and converts and outputs smoothed DC power into three-phase AC power of a predetermined frequency, and/or at least one motor that drives a fan 341 according to three-phase AC power output from the inverter.

Meanwhile, the fan driving part 340 may be provided with separate configurations for driving the outdoor fan 105a and the indoor fan 109a. For example, the air conditioner 100 may include a first fan driving part for driving the outdoor fan 105a and a second fan driving part for driving the indoor fan 109a.

A compressor driving part 350 may be provided to drive the compressor 102. The compressor driving part 350 may include a rectifier that rectifies AC power into DC power and outputs it, a DC-link capacitor that stores a pulsating voltage from the rectifier, an inverter that has a plurality of switching elements and converts and outputs smoothed DC power into three-phase AC power of a predetermined frequency, and/or a compressor motor 102b that drives the compressor 102 according to the three-phase AC power output from the inverter.

The controller 360 can control the overall operation of the air conditioner 100. The controller 360 can be connected to each component provided in the air conditioner 100. The controller 360 can control the overall operation by transmitting and/or receiving signals between each component provided in the air conditioner 100.

For example, the controller 360 can predict the contamination level of the indoor heat exchanger 108 through the temperature of the indoor heat exchanger 108 measured through the temperature sensor and the indoor humidity measured through the humidity sensor.

The controller 360 can predict the contamination level of the indoor heat exchanger 108 through a prediction model derived from machine learning based on big data that uses the temperature of the indoor heat exchanger 108 and the humidity of the room as factors. The contamination level of the indoor heat exchanger 108 can be quantified as a contamination index.

The controller 360 can calculate the accumulated contamination index of the indoor heat exchanger 108 by applying the temperature of the indoor heat exchanger 108 and the humidity of the room to the prediction model and integrating the contamination index. The controller 360 can periodically calculate the contamination index through the prediction model. For example, the controller 360 can calculate the contamination index at one-hour intervals.

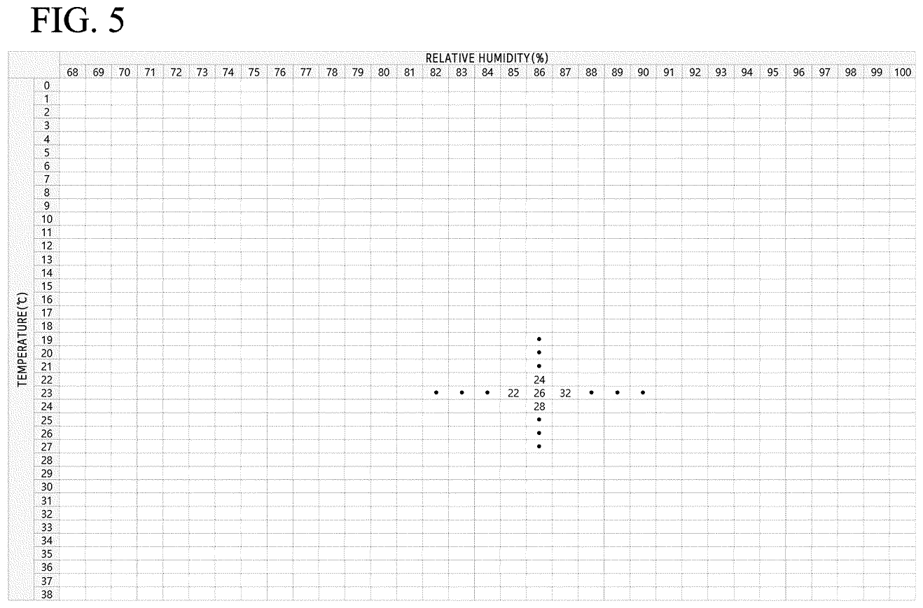

Accordingly, when the accumulated contamination index of the indoor heat exchanger 108 is equal to or greater than a predetermined reference value, cleaning of the indoor heat exchanger 108 can be performed. The cleaning process of the indoor heat exchanger 108 according to the accumulated contamination index of the indoor heat exchanger 108 will be described later with reference to FIG. 4.

For example, the controller 360 can control the operation of the fan driving part 340 to change the rotation speed of the fan 341. For example, the fan driving part 340 can change the rotation speed of the outdoor fan 105a by changing the frequency of the three-phase AC power output to the outdoor fan motor 105b according to the control of the controller 360. For example, the fan drive part 340 can change the rotation speed of the indoor fan 109a by changing the frequency of the three-phase AC power output to the indoor fan motor 109b according to the control of the controller 360.

For example, the controller 360 can control the operation of the compressor drive part 350 to change the operating frequency of the compressor 102. The compressor drive part 350 can change the frequency of the three-phase AC power output to the compressor motor 102b according to the control of the controller 360, thereby changing the operating frequency of the compressor 102.

For example, the controller 360 may be provided in the outdoor part 21, but is not limited thereto, and the controller 360 may be provided in the indoor part 31, or a central controller that controls the operation of the outdoor part 21 and the indoor part 31.

The controller 360 may include at least one processor and may control the overall operation of the air conditioner 100 using the processor included therein. For example, the processor may be a processor such as a CPU (central processing part).

The controller 360 can obtain data related to each component equipped in the air conditioner 100. At this time, the controller 360 can obtain data related to each component equipped in the air conditioner 100 at regular time intervals according to a predetermined cycle, taking into account the computational load. The controller 360 can perform various computations based on the acquired data, and can control the overall operation of each component equipped in the air conditioner 100 according to the computational results.

For example, data related to each component provided in the air conditioner 100 may include the operating frequency of the compressor 102, the suction temperature, the discharge temperature, the suction pressure, and the discharge pressure of the compressor 102, the inlet-side pipe temperature of the indoor part 31, the outlet-side pipe temperature of the indoor part 31, the indoor temperature, the outdoor temperature, the opening amount of the electronic expansion valve (EEV), or the like.

Meanwhile, the air conditioner 100 may further include an input device capable of receiving user input. For example, when the air conditioner 100 receives user input through an input device (for example, a touch panel, a key, or the like), the air conditioner may perform an operation corresponding to the received user input.

The air conditioner 100 may include a display part 370 that outputs a message about the operating status of the air conditioner 100. The display part 370 may output information about the overall operation of the air conditioner 100. For example, the display part 370 may output information about the contamination status of the indoor heat exchanger 108 and information about the cleaning operation of the indoor heat exchanger 108.

The display part 370 can output the contamination level of the indoor heat exchanger 108 predicted by a prediction model calculated through big data-based machine learning. In other words, the contamination level of the indoor heat exchanger 108 output by the display part 370 can be the expected contamination level calculated by the prediction model. For example, the display part 370 can output the expected contamination level of the indoor heat exchanger 108 as a numerical value.

In addition, the display part 370 can output the cleaning operation process of the indoor heat exchanger 108. For example, the display part 370 can output the current status during the cleaning operation process of the indoor heat exchanger 108.

The display part 370 may include a display device such as a display, a light emitting diode (LED), and/or an audio device such as a speaker or a buzzer. The display part 370 may be formed in the indoor part 31 or in a remote device 41 for controlling the air conditioner 100. In other words, the display part 370 may be a component included in the indoor part 31, but is not limited thereto and may be a component of a remote device 41 for controlling the air conditioner 100.

Hereinafter, a method for cleaning an indoor heat exchanger 108 through a controller 360 will be described with reference to FIGS. 4 to 8.

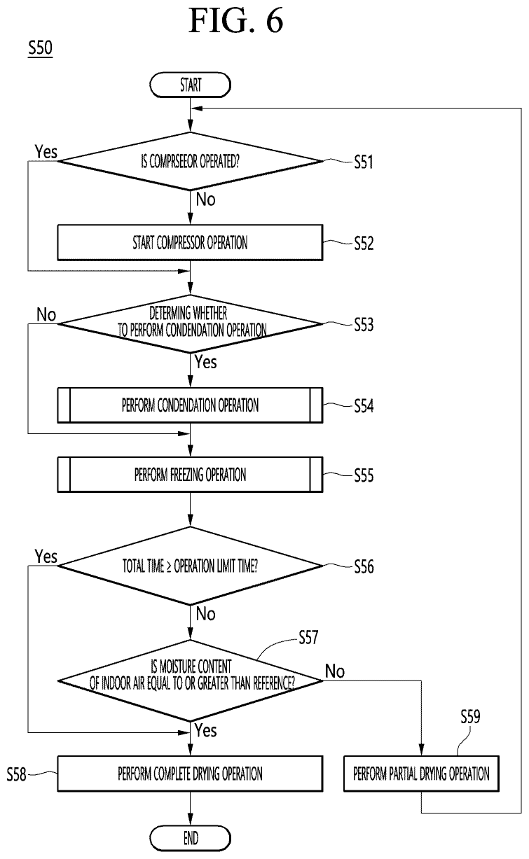

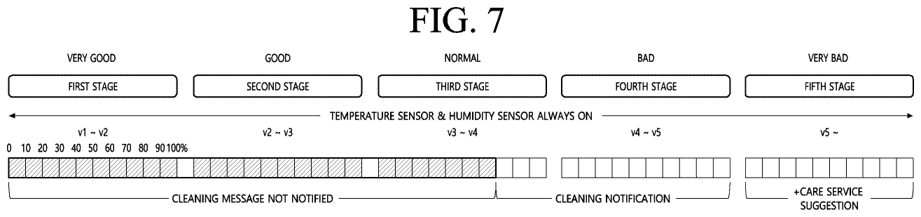

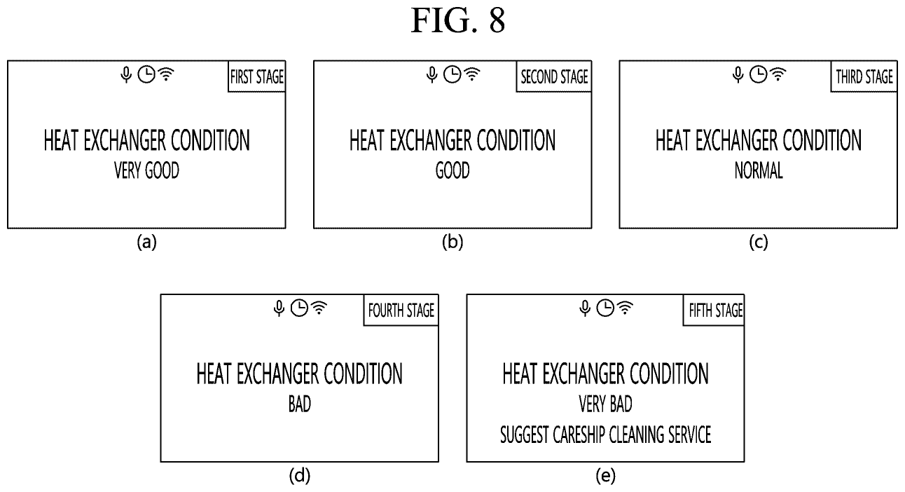

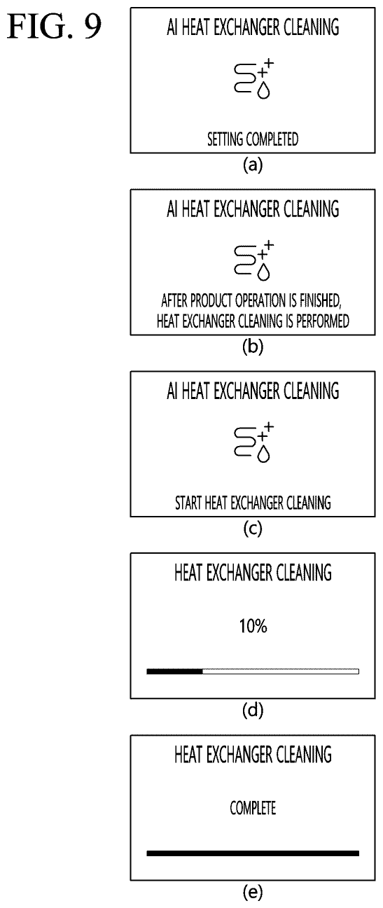

FIG. 4 is a flowchart illustrating an method for operating an air conditioner according to one embodiment. FIG. 5 is a contamination index table for accumulating the contamination index of an indoor heat exchanger of an air conditioner according to one embodiment. FIG. 6 is a flowchart illustrating a cleaning process of an indoor heat exchanger in an air conditioner according to one embodiment. FIG. 7 is a view illustrating an example of the contamination level of an indoor heat exchanger of an air conditioner according to one embodiment. FIG. 8 is a view illustrating an example of a display part of an air conditioner according to one embodiment indicating the status of a heat exchanger.

Referring to FIG. 4, the method for operating the air conditioner 100 according to one embodiment may include a step of initializing a accumulated contamination index (S10), a step of accumulating a contamination index (S20), a step of comparing the accumulated contamination index with a reference contamination index (S30), a step of notifying a heat exchanger to be cleaned (S31), a step of determining whether a cleaning condition is satisfied (S40), a step of performing indoor heat exchanger cleaning (S50), and a step of determining whether indoor heat exchanger cleaning is completed (S60). The method for operating the air conditioner 100 according to one embodiment may be performed by a controller 360.

In the method for operating the air conditioner 100 according to one embodiment, a step (S10) of initializing a accumulated contamination index may be performed first. The method for operating the air conditioner 100 according to one embodiment relates to a process of predicting the contamination level of an indoor heat exchanger 108 by periodically accumulating a contamination index calculated using a prediction model calculated through big data-based machine learning, and cleaning the indoor heat exchanger 108. Therefore, the step (S10) of initializing the accumulated contamination index of the indoor heat exchanger 108 may be performed first.

In the step of initializing the accumulated contamination index (S10), the controller 360 can initialize and store the accumulated contamination index. For example, the accumulated contamination index can be stored as 0. In addition, the controller 360 can initialize and store the accumulated contamination index to a value other than 0 based on the operating time or the number of cleaning cycles of the air conditioner.

Meanwhile, in this specification, the contamination index may mean a numerical value of the contamination level of an indoor heat exchanger 108 predicted through a prediction model calculated through big data-based machine learning.

After the step of initializing the accumulated contamination index (S10), the step of accumulating the contamination index (S20) may be performed. The step of accumulating the contamination index (S20) may be performed by the controller 360. The controller 360 may accumulate the contamination index of the indoor heat exchanger 108 predicted and digitized through a prediction model calculated through big data-based machine learning. The prediction model may calculate the contamination index of the indoor heat exchanger 108 by using the temperature of the indoor heat exchanger 108 measured through the temperature sensor 321 and the indoor humidity measured through the humidity sensor 322 as factors.

The controller 360 can calculate the pollution index through the prediction model, accumulate the calculated pollution index, and store it. The controller 360 can perform the calculation of the pollution index periodically. For example, the controller 360 can perform the calculation of the pollution index at one-hour intervals.

Meanwhile, a prediction model derived through big data-based machine learning may be loaded into the memory 330. As described above, the prediction model may be loaded into the memory 330 during the manufacturing stage by the manufacturer of the air conditioner 100 of the indoor heat exchanger 108.

The prediction model can be obtained through machine learning using big data of indoor heat exchanger 108 contamination data measured using the temperature of the indoor heat exchanger 108 and the relative humidity of the room where the indoor part 31 is disposed as factors.

Meanwhile, the prediction model may be installed and shipped during the manufacturing process of the air conditioner 100, but is not limited thereto and may be updated by receiving data from the management server of the air conditioner 100. Through this, the reliability of the prediction model installed in the air conditioner 100 may be improved.

In addition, a contamination index table that simplifies the prediction model can be loaded into memory 330 by the manufacturer during the manufacturing stage. The contamination index table can receive data or be updated through the management server.

Accordingly, the prediction model or contamination index table may be loaded into the memory 330 by the manufacturer before the user uses it and may be continuously updated through the management server. Referring to FIG. 5, FIG. 5 illustrates a contamination index table of an indoor heat exchanger 108 with the relative humidity of the room where the indoor part 31 is disposed as the horizontal axis and the temperature of the indoor heat exchanger 108 as the vertical axis. In other words, the table of FIG. 5 is a simplified version of the-described prediction model, and is configured to output a contamination index when the relative humidity of the room where the indoor part 31 is disposed and the temperature of the indoor heat exchanger 108 are specified. As an example, data for the table of FIG. 5 may be loaded into the memory 330 of the air conditioner 100.

In FIG. 5, only some data corresponding to cases where the indoor relative humidity is 85%, 86%, and 87% and the temperature of the indoor heat exchanger 108 is 22° C., 23° C., and 24° C. are illustrated, but this is only an example, and the prediction model loaded into the memory 330 of the air conditioner 100 may include all data corresponding to the indoor relative humidity in the range of about 68% to 100% and the temperature of the indoor heat exchanger 108 in the range of about 0° C. to 38° C. In other words, the prediction model may include all data corresponding to the indoor relative humidity and the indoor heat exchanger 108 temperature that may occur in the environment in which the air conditioner 100 is disposed.

Accordingly, the controller 360 can input the temperature of the indoor heat exchanger 108 measured through the temperature sensor 321 and the relative humidity of the room measured through the humidity sensor 322 into the prediction model loaded in the memory 330 to periodically calculate the pollution index, accumulate it, and store it.

In addition, the controller 360 can periodically calculate a pollution index corresponding to the temperature of the indoor heat exchanger 108 measured through the temperature sensor 321 and the relative humidity of the room measured through the humidity sensor 322 based on the pollution index table loaded in the memory 330, accumulate it, and store it.

Referring to FIG. 7, an air conditioner 100 according to one embodiment can define the contamination level of an indoor heat exchanger 108 according to the range of the contamination index. For example, the contamination level of the indoor heat exchanger 108 can be defined as a first stage (very good), a second stage (good), a third stage (normal), a fourth stage (bad), a fifth stage (very bad), or the like.

For example, as illustrated in FIG. 7, when the accumulated contamination index is equal to or greater than a first threshold value v1 and less than a second threshold value v2, the contamination level of the indoor heat exchanger 108 may be defined as a state of a first stage (very good). The first threshold value v1 may be set to 0. When the accumulated contamination index is equal to or greater than a second threshold value v2 and less than a third threshold value v3, the contamination level of the indoor heat exchanger 108 may be defined as a state of a second stage (good). When the accumulated contamination index is equal to or greater than a third threshold value v3 and less than a fourth threshold value v4, the contamination level of the indoor heat exchanger 108 may be defined as a state of a third stage (normal). When the accumulated contamination index is equal to or greater than a fourth threshold value v4 and less than a fifth threshold value v5, the contamination level of the indoor heat exchanger 108 may be defined as a state of a fourth stage (bad). When the accumulated contamination index is equal to or greater than the fifth threshold value v5, the contamination level of the indoor heat exchanger 108 can be defined as a fifth stage (very bad).

Meanwhile, the first threshold value v1 to the fifth threshold value v5 described above can be set in various ways according to the pollution index data value loaded into the prediction model.

Referring to FIG. 8, the air conditioner 100 according to one embodiment can output the contamination level of the indoor heat exchanger 108 through the display part 370. As described above, the display part 370 can be formed on the indoor part 31 and/or the remote device 41 for controlling the air conditioner 100. Accordingly, the user can check the contamination level of the indoor heat exchanger 108 in real time through the display part 370 formed on the indoor part 31 and/or the remote device 41.

FIG. 8 (a) to (e) respectively illustrate the screen of the display part 370 when the contamination level of the indoor heat exchanger 108 is at the first stage (very good), the second stage (good), the third stage (normal), the fourth stage (bad), and the fifth stage (very bad). In particular, when the contamination level of the indoor heat exchanger 108 is at the fifth stage (very bad), a phrase suggesting a cleaning service for the indoor heat exchanger 108 may be displayed on the display part 370.

After the step of accumulating the pollution index (S20), a step of comparing the accumulated pollution index with the reference pollution index (S30) may be performed. The step of comparing the accumulated pollution index with the reference pollution index (S30) may be performed in real time during the step of accumulating the pollution index (S20). The step of comparing the accumulated pollution index with the reference pollution index (S30) may be performed by the controller 360.

The accumulated pollution index may refer to a pollution index that is accumulated in real time in the step of accumulating the pollution index (S20).

The reference contamination index may mean a threshold value of the contamination index for performing cleaning of the indoor heat exchanger 108. For example, the reference contamination index may be included in a range of contamination indices indicating a state of the third stage (normal). For example, according to the contamination index criteria illustrated in FIGS. 5 and 7, the reference contamination index may be a value included in the third stage (normal). In other words, the reference contamination index may have a value equal to or greater than the third threshold value v3 and equal to or less than the fourth threshold value v4.

In the step (S30) of comparing the accumulated pollution index with the reference pollution index, if the accumulated pollution index is less than the reference pollution index, the process may return to the step (S20) of accumulating the pollution index. Meanwhile, since the step (S30) of comparing the accumulated pollution index with the reference pollution index may be performed during the step (S20) of accumulating the pollution index, it may be understood that the step (S20) of accumulating the pollution index is continuously performed.

Meanwhile, in the step (S30) of comparing the accumulated contamination index with the reference contamination index, if the accumulated contamination index is equal to or higher than the reference contamination index, the heat exchanger cleaning notification step (S31) can be performed.

In the heat exchanger cleaning notification step (S31), the controller 360 can notify the user that the indoor heat exchanger 108 needs to be cleaned. For example, the controller 360 can notify the user that the indoor heat exchanger 108 needs to be cleaned through the display part 370. Alternatively, the controller 360 can notify the user that the indoor heat exchanger 108 needs to be cleaned through the remote device 41.

Meanwhile, the heat exchanger cleaning notification step (S31) may be performed during operation of the air conditioner 100, but is not limited thereto and may also be performed at the end of operation and/or start of operation of the air conditioner 100.

After the heat exchanger cleaning notification step (S31), a step (S40) for determining whether the cleaning conditions are satisfied may be performed. The step (S40) for determining whether the cleaning conditions are satisfied may be performed by the controller 360.

The step (S40) of determining whether the cleaning condition is satisfied may be performed to determine whether the indoor heat exchanger 108 is in an environment suitable for cleaning. The cleaning condition of the indoor heat exchanger 108 may be determined by the outdoor temperature where the outdoor part 21 is disposed and the indoor temperature where the indoor part 31 is disposed.

For example, the cleaning conditions of the indoor heat exchanger 108 may be that the outdoor temperature is in the range of 21° C. or more and 37° C. or less, and the indoor temperature is in the range of 21° C. or more and 32° C. or less.

In the step (S40) of determining whether the cleaning condition is satisfied, if the indoor heat exchanger 108 does not satisfy the cleaning condition, the process may return to the step (S20) of accumulating the contamination index. Meanwhile, since the step (S40) of determining whether the cleaning condition is satisfied may be performed during the step (S20) of accumulating the contamination index, it may be understood that the step (S20) of accumulating the contamination index is continuously performed.

Meanwhile, in the step (S40) of determining whether the cleaning conditions are satisfied, if the cleaning conditions of the indoor heat exchanger 108 are satisfied, the step (S50) of performing indoor heat exchanger cleaning can be performed.

Below, the step (S50) of cleaning the indoor heat exchanger is described in detail with reference to FIG. 6.

Referring to FIG. 6, the step (S50) of performing cleaning of an indoor heat exchanger 108 may include a step (S51) of checking whether a compressor is operating, a step (S52) of starting the compressor, a step (S53) of determining whether a condensation operation is performed, a step (S54) of performing a condensation operation, a step (S55) of performing a freezing operation, a step (S56) of determining whether the total cleaning time is equal to or longer than the operation limit time, a step (S57) of determining whether the moisture content of indoor air is equal to or greater than a reference, and a step (S58, S59) of performing a complete drying operation or a partial drying operation.

First, a step (S51) of checking whether the compressor is operating can be performed. In an air conditioner 100 according to one embodiment, if the compressor 102 can sufficiently compress the introduced refrigerant into a high-temperature, high-pressure gaseous refrigerant according to the purpose, it can be determined that the compressor 102 is operating and the refrigerant cycle is stabilized. For example, the air conditioner 100 can check whether the compressor 102 is operating based on the operating frequency, suction temperature, discharge temperature, suction pressure, discharge pressure, or the like of the compressor 102.

In the step (S51) of checking whether the compressor is operating, if it is determined that the compressor 102 is operating, the step (S53) of determining whether a condensation operation is performed can be performed. The step (S53) of determining whether a condensation operation is performed will be described later.

Meanwhile, if it is determined that the compressor 102 is not driven in the step (S51) of checking whether the compressor is driven, the step (S52) of starting the compressor may be performed. The step (S52) of starting the compressor may be a step in which the controller 360 controls the compressor driving part 350 to start the compressor 102. In the step (S52) of starting the compressor, the air conditioner 100 may control the operation of each component according to preset conditions so that the operating frequency of the compressor 102 reaches a predetermined frequency. For example, the air conditioner 100 may open the electronic expansion valve 106 (EEV) according to a preset opening amount when starting the compressor 102. At this time, the air conditioner 100 may control the operation of each component according to the cooling mode for cooling the indoor space.

Meanwhile, when the compressor 102 is started up in the step (S52) of starting the compressor, a step (S53) of determining whether to perform a condensation operation may be performed. The condensation operation may refer to an operation of the air conditioner 100 to cause moisture contained in indoor air to form water droplets on the surface of the indoor heat exchanger 108. For example, the air conditioner 100 may be preset to perform a condensation operation when performing an operation for removing foreign substances. In addition, the air conditioner 100 may output a message regarding the performance of the condensation operation through an output device, and may determine whether to perform the condensation operation in response to a user input received through an input device. At this time, when there is a history of receiving a user input regarding the performance of the condensation operation in the past, the air conditioner 100 may determine whether to perform the condensation operation in accordance with the previously received user input without outputting a message regarding the performance of the condensation operation through the output device.

Meanwhile, if it is determined in step (S53) of determining whether to perform a condensation operation that the condensation operation is not to be performed, a step (S55) of performing a freezing operation may be performed. Here, the freezing operation may mean an operation of the air conditioner 100 to form ice on the surface of the indoor heat exchanger 108.

In the step (S53) of determining whether to perform a condensation operation, if it is determined that a condensation operation is to be performed, a step (S54) of performing a condensation operation may be performed. If the condensation operation is completed in the step (S54) of performing a condensation operation, a step (S55) of performing a freezing operation may be performed.

In the step (S55) of performing the freezing operation, if the freezing operation is completed, a step (S56) of determining whether the total cleaning time is equal to or longer than the operation limit time may be performed. The total cleaning time may mean the total time elapsed from the time the freezing operation was first initiated.

In the step (S56) of determining whether the total cleaning time is equal to or longer than the operation limit time, if the total cleaning time is equal to or longer than the operation limit time, the step (S58) of performing a complete drying operation can be performed. The step (S58) of performing a complete drying operation will be described later.

In the step (S56) of determining whether the total cleaning time is longer than the operation limit time, if the total cleaning time is shorter than the operation limit time, a step (S57) of determining whether the moisture content of the indoor air is equal to or greater than a reference may be performed. For example, the air conditioner 100 may receive data on the dry bulb temperature of the indoor air from the indoor temperature sensor, and may receive data on the relative humidity from the indoor humidity sensor. At this time, the air conditioner 100 may calculate at least one of the wet bulb temperature and the absolute humidity of the indoor air using a calculation formula based on the psychrometric chart, and may determine whether the amount of moisture contained in the indoor air is equal to or greater than a preset reference based on the calculation result. Even if the relative humidity of the indoor air is high, the indoor air may not contain a sufficient level of moisture in cases such as when the indoor temperature is low. At this time, if the condensation operation and freezing operation are simply finished due to the high relative humidity of the indoor air, the amount of moisture condensed in the indoor heat exchanger 108 may not be sufficient according to the amount of moisture contained in the indoor air.

In addition, even if the relative humidity of the indoor air is low, the indoor air may contain a sufficient level of moisture in cases such as when the indoor temperature is high. At this time, even though a sufficient amount of moisture for removing foreign substances is condensed and frozen in the indoor heat exchanger 108, if the condensation and freezing operations are repeated due to the low relative humidity of the indoor air, unnecessary power consumption may occur.

Accordingly, in order to sufficiently condense and freeze moisture for removing foreign substances in the indoor heat exchanger 108 while reducing unnecessary power consumption, the air conditioner 100 can determine whether to repeat the condensation and freezing operations based on the absolute value of the amount of moisture contained in the indoor air, not the relative humidity.

In the step (S57) of determining whether the moisture content of indoor air is equal to or greater than a reference, if the moisture content of indoor air is determined to be equal to or greater than the reference, a step (S58) of performing a complete drying operation may be performed. In the step (S58) of performing a complete drying operation, the air conditioner 100 may perform an operation of removing all condensed and frozen moisture in the indoor heat exchanger 108 from the indoor heat exchanger 108. For example, in the step (S58) of performing a complete drying operation, the air conditioner 100 may finish the operation of the compressor 102 and control the indoor fan 109a to rotate at a first speed for a first drying time. At this time, the moisture condensed and frozen in the indoor heat exchanger 108 may be thawed and then removed.

In the step (S57) of determining whether the moisture content of indoor air is equal to or greater than a reference, if the moisture content of indoor air is determined to be less than the reference, a step (S59) of performing some drying operation may be performed.

In the step (S59) of performing a partial drying operation, the air conditioner 100 may perform an operation of partially removing condensed and frozen moisture in the indoor heat exchanger 108 from the indoor heat exchanger 108. For example, in the step (S59) of performing a partial drying operation, the air conditioner 100 may finish the operation of the compressor 102 and control the indoor fan 109a to rotate at a second speed for a second drying time. At this time, after the condensed and frozen moisture in the indoor heat exchanger 108 thaws, only a part of the condensed and frozen moisture may be removed. Meanwhile, the second drying time may be shorter than the first drying time. The second speed in the step (S59) of performing a partial drying operation may be slower than the first speed in the step (S58) of performing a complete drying operation. Meanwhile, the second speed in the step (S59) of performing some drying operation may be faster than the rotation speed of the indoor fan 108a in the freezing operation and/or the condensation operation.

When the step (S50) of cleaning the indoor heat exchanger is finished, the step (S60) of determining whether cleaning the indoor heat exchanger is completed can be performed.

Meanwhile, the step (S50) of cleaning the indoor heat exchanger may be finished for various reasons. For example, the step (S50) of cleaning the indoor heat exchanger may be finished when the cleaning of the indoor heat exchanger 108 is completed. Meanwhile, the step (S50) of cleaning the indoor heat exchanger may be finished even when the cleaning of the indoor heat exchanger 108 is not completed. For example, the step (S50) of cleaning the indoor heat exchanger may be finished by a user's stop command or an operation error of the air conditioner 100, either of which interrupt the heat exchanger cleaning process.

In the step (S60) of determining whether the indoor heat exchanger cleaning is completed, if the step (S50) of performing the indoor heat exchanger cleaning is finished because the cleaning of the indoor heat exchanger 108 is completed, the step (S10) of re-initializing the contamination index can be performed.

On the other hand, in the step (S60) of determining whether the indoor heat exchanger cleaning is completed, if the step (S50) of performing the indoor heat exchanger cleaning is finished in a situation where the cleaning of the indoor heat exchanger 108 is not completed, the process may return to the step (S30) of comparing the accumulated contamination index with the reference contamination index. However, the process is not limited thereto, and in the step (S60) of determining whether the indoor heat exchanger cleaning is completed, if the step (S50) of performing the indoor heat exchanger cleaning is finished in a situation where the cleaning of the indoor heat exchanger 108 is not completed, the process may return to the step (S20) of accumulating the contamination index.

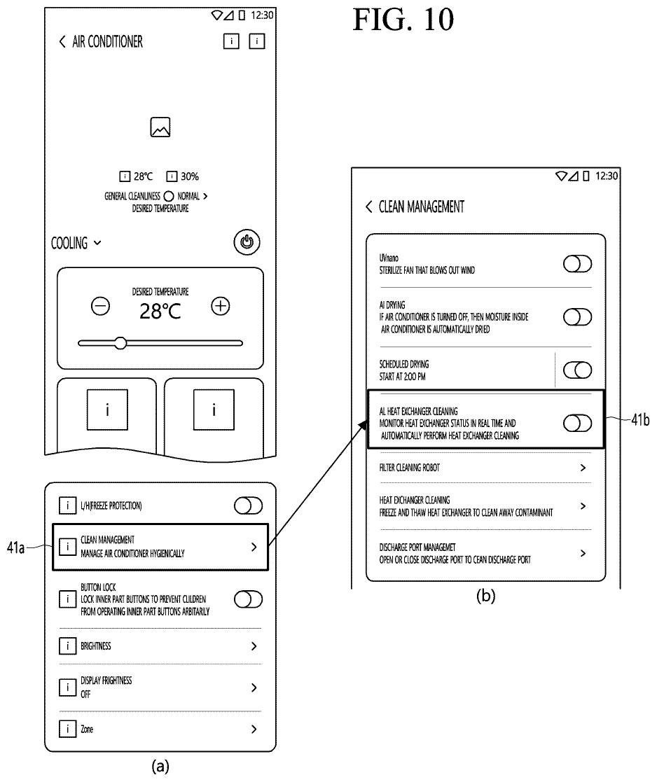

Hereinafter, with reference to FIGS. 9 to 11, an output screen of a display part 370 related to an operating method of an air conditioner 100 according to one embodiment will be described.

FIG. 9 is a view illustrating an example of a display part of an air conditioner according to one embodiment indicating the status of a heat exchanger cleaning operation.

Referring to FIG. 9, the method for operating the air conditioner 100 according to one embodiment can be performed according to the user's settings. In other words, the cleaning of the indoor heat exchanger 108 can be performed by calculating the predicted contamination level of the indoor heat exchanger 108 through the temperature of the indoor heat exchanger 108 and the indoor relative humidity, cleaning of the indoor heat exchanger 108 can be performed when set by the user.

FIG. 9 (a) may be a screen output by the display part 370 when the user sets the method for operating the air conditioner 100 according to one embodiment. FIG. 9 (b) may be a screen output by the display part 370 in the heat exchanger cleaning notification step (S31) described above with reference to FIG. 4. FIGS. 9 (c), (d), and (e) may be screens output by the display part 370 in the indoor heat exchanger cleaning step (S50) described above with reference to FIG. 4. For example, FIG. 9 (c) is output when the cleaning of the indoor heat exchanger 108 starts, FIG. 9 (d) is output while the cleaning of the indoor heat exchanger 108 is in progress, and FIG. 9 (e) is output when the cleaning of the indoor heat exchanger 108 is completed.

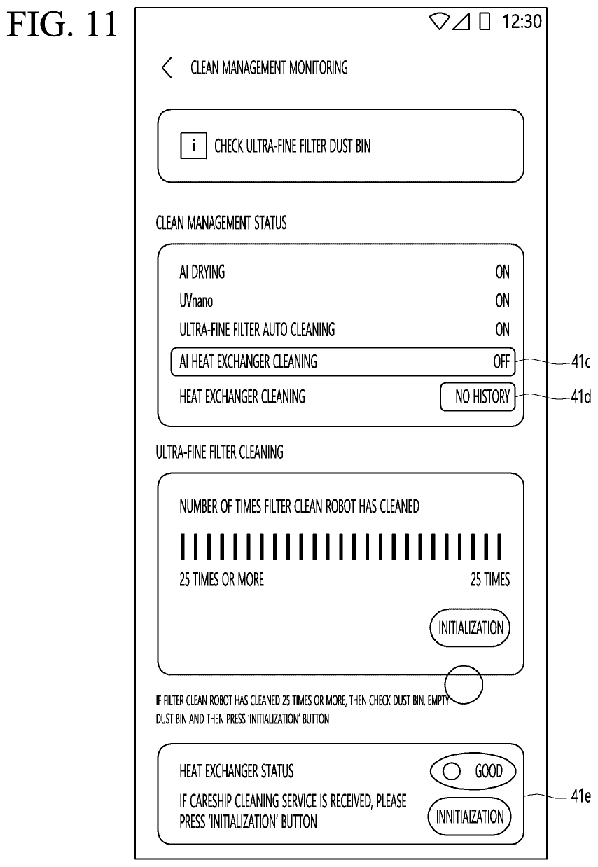

FIGS. 10 and 11 are views illustrating an example of a screen of a remote device capable of controlling a method for operating an air conditioner according to one embodiment.

FIG. 10 (a) is a control screen of an air conditioner 100, and the control screen may include a clean management tab 41a that can hygienically manage the air conditioner 100. When the clean management tab 41a is selected, the clean management screen of FIG. 10 (b) may appear on the remote device 41.

The clean management screen of FIG. 10 (b) may include an Al heat exchanger cleaning tab 41b that can control on/off of a method for operating an air conditioner 100 according to one embodiment for cleaning an indoor heat exchanger 108. The user can select whether to apply the method for operating the air conditioner 100 according to one embodiment by turning the Al heat exchanger cleaning tap 41b on and off.

FIG. 11 is a screen for monitoring the status of an indoor heat exchanger 108, and the monitoring screen may include an Al heat exchanger cleaning status tab 41c for checking whether a method for operating an air conditioner 100 according to one embodiment is applied, a heat exchanger cleaning history check tab 41d for checking the cleaning history of an indoor heat exchanger 108, and a heat exchanger status tab 41e for checking the contamination level of an indoor heat exchanger 108.

The Al heat exchanger cleaning status tab 41c may indicate the on/off status of the method for operating the air conditioner 100 according to one embodiment of performing automatic cleaning of the indoor heat exchanger 108. For example, when the Al heat exchanger cleaning status tab 41c is selected, the cleaning management screen of FIG. 10 (b) may appear.

The heat exchanger cleaning history check tab 41d can output the number of times the cleaning operation of the indoor heat exchanger 108 has been performed. For example, in the step (S60) of determining whether the cleaning of the indoor heat exchanger is completed as described above with reference to FIG. 4, if the step (S50) of performing the cleaning of the indoor heat exchanger is determined to have finished because the cleaning of the indoor heat exchanger 108 has been completed, the number of times the cleaning operation of the heat exchanger cleaning history check tab 41d has been performed can be counted.

The heat exchanger status tab 41e can output the contamination level calculated through the contamination index of the indoor heat exchanger 108. For example, the contamination level information of the indoor heat exchanger 108 described above with reference to FIG. 8 can be displayed in synchronization on the heat exchanger status tab 41e.

Meanwhile, the present disclosure may have various other embodiments in addition to the-described embodiments. Hereinafter, other embodiments of the present disclosure will be described with reference to the drawings. Among the configurations of other embodiments, the configurations that are identical to the aforementioned embodiments may be omitted from description and illustration, and may be described using the same drawing reference numerals. In other words, only structures that are different from the above-described embodiment are described below, and other configurations not described may be the same as the above-described embodiment.

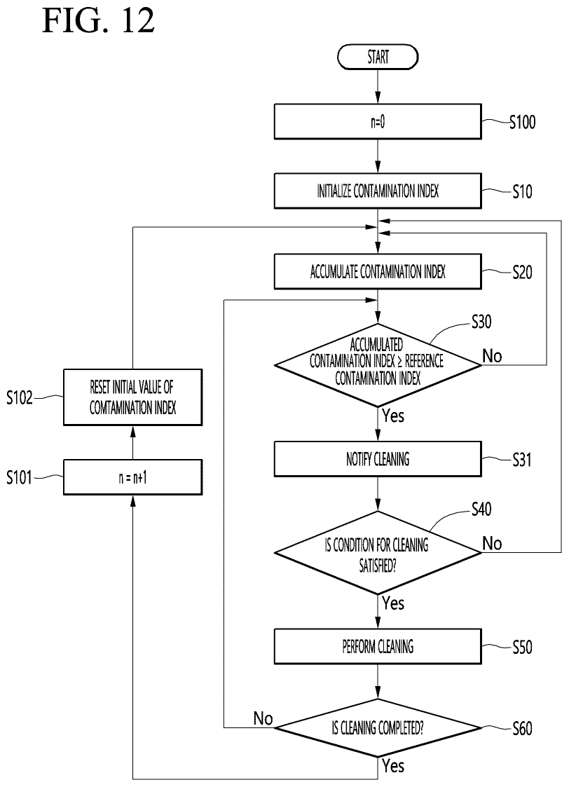

FIG. 12 is a flowchart illustrating a method for operating an air conditioner according to another embodiment.

Referring to FIG. 12, the method for operating the air conditioner 100 according to the present embodiment is different from the embodiment of FIG. 4 in that the number of times n of cleaning the indoor heat exchanger 108 is counted and this is reflected when resetting the initial value of the contamination index of the indoor heat exchanger 108.

Below, the present embodiment will be described with a focus on the differences from the embodiment of FIG. 4.

The method for operating the air conditioner 100 according to the present embodiment may further include a step (S100) of initializing the number of times n of cleaning the indoor heat exchanger 108 prior to the step (S10) of initializing the contamination index when the air conditioner 100 is first operated, in a step (S60) of determining whether cleaning of the indoor heat exchanger is completed, a step (S101) of counting the number of times n of cleaning the indoor heat exchanger 108 performed when the step (S50) of cleaning the indoor heat exchanger is completed and finished, and a step (S102) of resetting the initial value of the contamination index performed after the step (S101) of counting the number of times n of cleaning the indoor heat exchanger 108.

When the air conditioner 100 is first operated, a step (S100) of initializing the number of times n of cleaning the indoor heat exchanger 108 may be performed before a step (S10) of initializing the contamination index. However, in this embodiment, the order of the step (S10) of initializing the contamination index and the step (S100) of initializing the number of times n of cleaning the indoor heat exchanger may be changed.

Meanwhile, in the step (S60) of determining whether the indoor heat exchanger cleaning is completed, if the step (S50) of cleaning the indoor heat exchanger has finished with the cleaning of the indoor heat exchanger 108 completed, the step (S101) of counting the number of times n of cleaning the indoor heat exchanger 108 has been cleaned may be performed. The step (S101) of counting the number of times n of cleaning the indoor heat exchanger may be performed only if the step (S50) of cleaning the indoor heat exchanger has finished with the cleaning of the indoor heat exchanger 108 completed. In other words, if the step (S50) of cleaning the indoor heat exchanger has finished without the cleaning of the indoor heat exchanger 108 being completed, the step (S30) of comparing the accumulated contamination index with the reference contamination index may be performed again.

The step (S101) of counting the number of times n of cleaning the indoor heat exchanger 108 can be performed to reflect the number of times n of cleaning the indoor heat exchanger 108 when resetting the contamination index of the indoor heat exchanger 108.

After the step (S101) of counting the number of times n of cleaning the indoor heat exchanger 108, the step (S102) of resetting the initial value of the contamination index can be performed. The step (S102) of resetting the initial value of the contamination index is a step of resetting the initial value of the contamination index that is set before the step (S20) of accumulating the contamination index.

In the step (S50) of cleaning the indoor heat exchanger, foreign substances adsorbed on the indoor heat exchanger 108 may not be completely removed. Therefore, the step (S102) of resetting the initial value of the contamination index may be performed to set the initial value of the contamination index to a predetermined value.

The initial value of the contamination index set in the step (S102) of resetting the initial value of the contamination index may depend on the number of times n of cleaning the indoor heat exchanger 108. For example, the initial value of the contamination index set in the step (S102) of resetting the initial value of the contamination index may increase as the number of times n of cleaning the indoor heat exchanger 108 increases.

The correlation between the initial value of the contamination index set in the step (S102) of resetting the initial value of the contamination index and the number of times n of cleaning the indoor heat exchanger 108 can be stored in the memory 330. For example, the correlation between the initial value of the contamination index set in the step (S102) of resetting the initial value of the contamination index and the number of times n of cleaning the indoor heat exchanger 108 can be calculated through a prediction model calculated through big data-based machine learning.

According to the present embodiment, as the number of times n of cleaning the indoor heat exchanger 108 increases, the time until the accumulated contamination index is equal to or higher than the reference contamination index in the step (S30) of comparing the accumulated contamination index with the reference contamination index may gradually decrease. In other words, the cycle in which the step (S50) of cleaning the indoor heat exchanger is performed may gradually decrease. At this time, as the number of times n of cleaning the indoor heat exchanger 108 increases, the reference contamination index may be maintained. Through this, the contamination level of the indoor heat exchanger 108 may be efficiently managed.

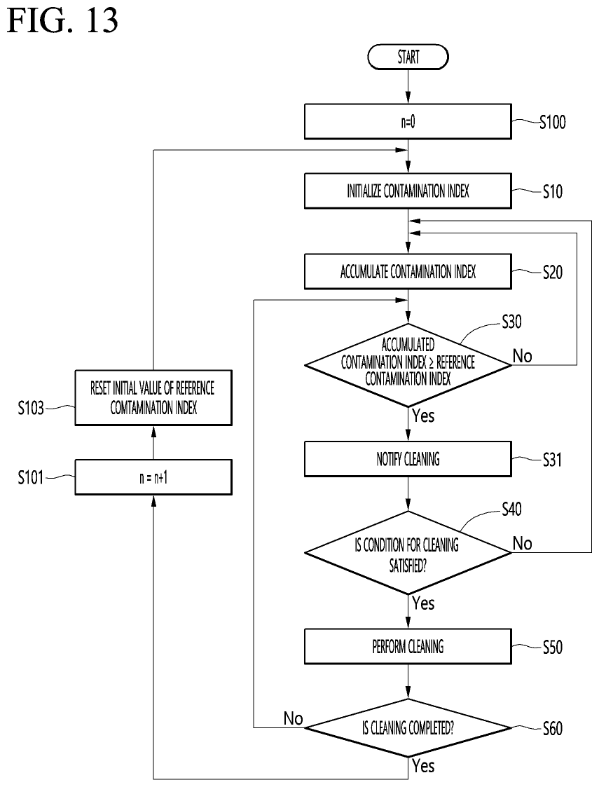

FIG. 13 is a flowchart illustrating a method for operating an air conditioner according to another embodiment.

Referring to FIG. 13, the method for operating the air conditioner 100 according to the present embodiment is different from the embodiment of FIG. 4 in that the number of times n of cleaning the indoor heat exchanger 108 is counted and this is reflected when resetting the reference contamination index.

Below, the present embodiment will be described with a focus on the differences from the embodiment of FIG. 12.

The method for operating the air conditioner 100 according to the present embodiment may further include a step (S102) of resetting the initial value of the contamination index performed after the step (S101) of counting the number of times n of cleaning the indoor heat exchanger 108.

The step (S101) of counting the number of times n of cleaning the indoor heat exchanger 108 can be performed to reflect the number of times n of cleaning the indoor heat exchanger 108 when resetting the contamination index of the indoor heat exchanger 108.

After the step (S101) of counting the number of times n of cleaning the indoor heat exchanger 108, the step (S103) of resetting the reference contamination index can be performed. The step (S103) of resetting the reference contamination index is a step of resetting the reference contamination index that serves as a reference in the step (S30) of comparing the accumulated contamination index with the reference contamination index.

In the step (S50) of cleaning the indoor heat exchanger, foreign substances adsorbed on the indoor heat exchanger 108 may not be completely removed. Therefore, the step (S103) of resetting the reference contamination index may be performed to correct the reference contamination index as the number of times n of cleaning the indoor heat exchanger 108 increases.

The reference contamination index set in the step (S103) of resetting the reference contamination index may depend on the number of times n of cleaning the indoor heat exchanger 108. For example, the reference contamination index reset in the step (S103) of resetting the reference contamination index may decrease as the number of times n of cleaning the indoor heat exchanger 108 increases.

The correlation between the reference contamination index set in the step (S103) of resetting the reference contamination index and the number of times n of cleaning the indoor heat exchanger 108 can be stored in the memory 330. For example, the correlation between the reference contamination index reset in the step (S103) of resetting the reference contamination index and the number of times n of cleaning the indoor heat exchanger 108 can be calculated through a prediction model calculated through big data-based machine learning.

After the step (S103) of resetting the reference contamination index, the process can return to the step (S10) of initializing the contamination index.

According to the present embodiment, as the number of times n of cleaning the indoor heat exchanger 108 increases, the time until the accumulated contamination index is equal to or higher than the reference contamination index in the step (S30) of comparing the accumulated contamination index with the reference contamination index may gradually decrease. In other words, the cycle in which the step (S50) of cleaning the indoor heat exchanger is performed may gradually decrease. At this time, as the number of times n of cleaning the indoor heat exchanger 108 increases, the reference contamination index may be maintained. Through this, the contamination level of the indoor heat exchanger 108 may be efficiently managed.

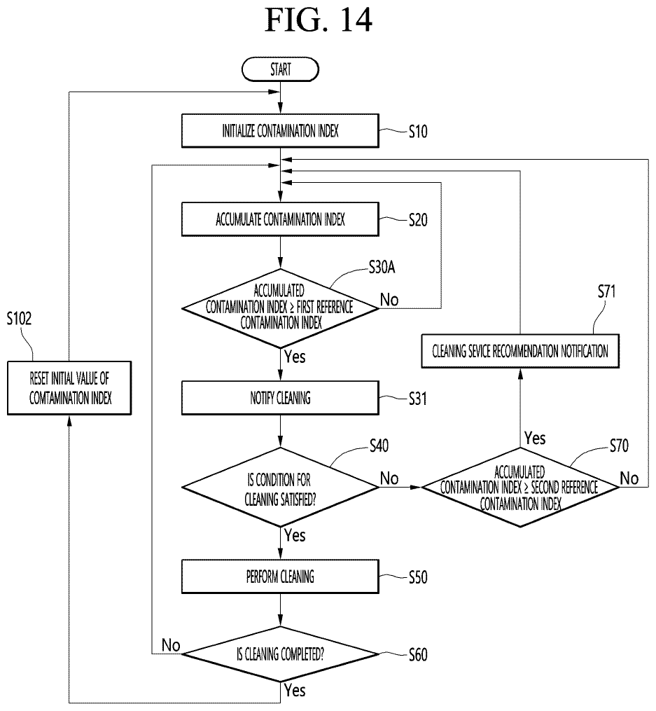

FIG. 14 is flowchart illustrating a method for operating an air conditioner according to another embodiment.

Referring to FIG. 14, the method for operating the air conditioner 100 according to the present embodiment is different from the embodiment of FIG. 4 in that cleaning of the indoor heat exchanger 108 and a cleaning service recommendation notification are performed through multiple comparisons with the reference contamination index.

Below, the present embodiment will be described with a focus on the differences from the embodiment of FIG. 4.

The method for operating the air conditioner 100 according to the present embodiment may further include a step (S30A) of comparing the accumulated contamination index with a first reference contamination index, which is performed after the step (S20) of accumulating the contamination index, a step (S70) of comparing the accumulated contamination index with a second reference contamination index, which is performed if the indoor heat exchanger 108 does not satisfy the cleaning conditions in the step (S40) of determining whether the cleaning conditions are satisfied, and in the step (S70) of comparing the accumulated contamination index with the second reference contamination index, a cleaning service recommendation notification step (S71) performed when the accumulated contamination index is equal to or higher than the second reference contamination index.

After the step (S20) of accumulating the contamination index, the step (S30A) of comparing the accumulated contamination index with the first reference contamination index may be performed. The step (S30A) of comparing the accumulated contamination index with the first reference contamination index (S30A) may be performed in real time during the step (S20) of accumulating the contamination index. The step (S30A) of comparing the accumulated contamination index with the first reference contamination index may be performed by the controller 360. For example, in the present embodiment, the first reference contamination index may be the same as the reference contamination index of the step (S30) of comparing the accumulated contamination index with the reference contamination index in the embodiment described above with reference to FIG. 4.

In other words, the step (S30A) of comparing the accumulated contamination index with the first reference contamination index of the present embodiment may be substantially identical to the step (S30) of comparing the accumulated contamination index with the reference contamination index in the embodiment described above with reference to FIG. 4.

In the step (S40) of determining whether the cleaning conditions of the present embodiment are satisfied, if the cleaning conditions of the indoor heat exchanger 108 are not satisfied, a step (S70) of comparing the accumulated contamination index with the second reference contamination index can be performed.

The second reference contamination index may refer to a threshold value of the contamination index for performing a cleaning service recommendation notification of the indoor heat exchanger 108. The second reference contamination index may be greater than the first reference contamination index. For example, the second reference contamination index may be a minimum value of the contamination index indicating the state of the fifth stage (very bad) described above with reference to FIG. 7. For example, according to the contamination index criteria illustrated in FIG. 5 and FIG. 7, the second reference contamination index may be a fifth threshold value v5. However, the present disclosure is not limited thereto, and the second reference contamination index may be changed according to the settings of a user or a manufacturer.

In the step (S70) of comparing the accumulated contamination index with the second reference contamination index, if the accumulated contamination index is less than the second reference contamination index, the step (S20) of accumulating the contamination index may be performed.

Meanwhile, in the step (S70) of comparing the accumulated contamination index with the second reference contamination index, if the accumulated contamination index is equal to or higher than the second reference contamination index, the cleaning service recommendation notification step (S71) may be performed.

In the cleaning service recommendation notification step (S71) of the present embodiment, the cleaning service may mean that the worker directly cleans the indoor heat exchanger 108. Since the cleaning process of the indoor heat exchanger 108 described above with reference to FIG. 6 is performed by the indoor part 31 itself through condensation, freezing, and drying operations, there may be a limit to the cleaning of the indoor heat exchanger 108. Accordingly, when the accumulated contamination index of the indoor heat exchanger 108 is equal to or greater than a certain level (second reference contamination index), a notification recommending the cleaning service may be performed (S71). Whether the cleaning service recommendation notification step (S71) is performed may be turned on and off by the user.

After the cleaning service recommendation notification step (S71), a contamination index accumulation step (S20) can be performed.

In the step (S60) of determining whether cleaning of the indoor heat exchanger is completed in this embodiment, if the step (S50) of cleaning the indoor heat exchanger is finished because cleaning of the indoor heat exchanger 108 is completed, the step (S102) of resetting the initial value of the contamination index can be performed.

The step (S102) of resetting the initial value of the contamination index is a step of resetting the initial value of the contamination index set before the step (S20) of accumulating the contamination index.

In the step (S50) of cleaning the indoor heat exchanger, foreign substances adsorbed on the indoor heat exchanger 108 may not be completely removed. Therefore, the step (S102) of resetting the initial value of the contamination index may be performed to set the initial value of the contamination index to a predetermined value.

For example, in the step (S102) of resetting the initial value of the contamination index, the initial value of the contamination index may be initialized to 0 and reset. However, the present disclosure is not limited thereto, and in the step (S102) of resetting the initial value of the contamination index of the present embodiment, the initial value of the contamination index may be set to a value that depends on the number of times n of cleaning the indoor heat exchanger 108, as in the embodiment described above with reference to FIG. 12.

In addition, as another embodiment, instead of the step (S102) of resetting the initial value of the contamination index as described above with reference to FIG. 13, a step (S103) of resetting the reference contamination index may be performed. In addition, the initial value of the reference contamination index may be set to a value that depends on the number of times n of cleaning the indoor heat exchanger 108 as in the embodiment described above with reference to FIG. 13.

Meanwhile, after the step (S102) of resetting the initial value of the contamination index, the process can return to the step (S20) of accumulating the contamination index.

According to this embodiment, there is a difference in that the accumulated contamination index is compared with multiple reference values such as first and second reference contamination indices to determine whether the indoor heat exchanger (108) should be cleaned and whether a cleaning service recommendation notification is issued. According to this embodiment, the contamination level can be prevented from increasing excessively due to continued use of the air conditioner 100 through the cleaning service recommendation notification. Through this, the contamination level of the indoor heat exchanger 108 of the air conditioner 100 can be efficiently managed.

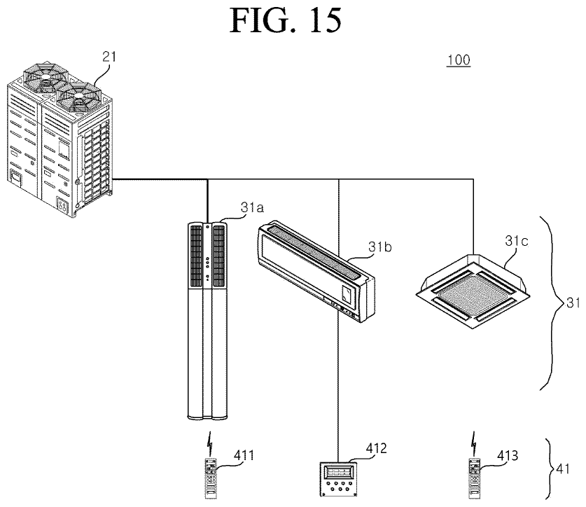

FIG. 15 is a view illustrating the configuration of an air conditioner according to another embodiment including a plurality of indoor parts.

The air conditioner 100 may include a plurality of indoor parts 31 connected to an outdoor part 21. For example, the air conditioner 100 may include a stand-alone indoor part 31a, a wall-mounted indoor part 31b, and/or a ceiling-mounted indoor part 31c.

A plurality of remote devices 41 are connected to a plurality of indoor parts 31, respectively, to transmit a user's control command to the indoor part 31 and to receive and display status information of the indoor part 31. At this time, each of the plurality of remote devices 41 can communicate wiredly or wirelessly according to the connection type with the corresponding indoor part 31. For example, the plurality of remote devices 41 may include a first remote device 411 connected to a stand-alone indoor part 31a, a second remote device 412 connected to a wall-mounted indoor part 31b, and a third remote device 413 connected to a ceiling-type indoor part 31c.

The air conditioner 100 can perform an operation (for example, condensation operation, freezing operation) for removing foreign substances for at least one of the plurality of indoor parts 31. At this time, the power of the remaining indoor parts, except for the indoor part in which the operation for removing foreign substances is performed, among the plurality of indoor parts 31, can be turned off.

For example, when the air conditioner 100 performs an operation for removing foreign substances from the stand-alone indoor part 31a, the power of the wall-mounted indoor part 31b and the ceiling-mounted indoor part 31c may be turned off. At this time, the refrigerant supplied from the outdoor part 21 may be delivered only to the stand-alone indoor part 31a, and may not be delivered to the wall-mounted indoor part 31b and the ceiling-mounted indoor part 31c.

Meanwhile, the air conditioner 100 according to the present embodiment may perform an operation for removing foreign substances for all of the plurality of indoor parts 31. At this time, the refrigerant supplied from the outdoor part 21 may be delivered to all of the plurality of indoor parts 31, and the operation for removing foreign substances (for example, condensation operation, freezing operation) may be performed simultaneously in the plurality of indoor parts 31.

As described above, according to at least one embodiment of the present disclosure, foreign substances adsorbed on the indoor heat exchanger 108 can be effectively removed by causing moisture contained in indoor air to be gradually condensed, frozen, and dried on the surface of the indoor heat exchanger 108.

Additionally, according to at least one embodiment of the present disclosure, by adjusting the operating frequency of the compressor 102 to correspond to the dew point temperature of the indoor air, the amount of moisture condensed in the indoor heat exchanger 108 can be increased.

In addition, according to at least one embodiment of the present disclosure, by controlling the operating frequency of the compressor 102 based on the compression ratio of the compressor 102, damage to the compressor 102 that may occur while moisture condensed in the indoor heat exchanger 108 freezes can be prevented.

In addition, according to at least one embodiment of the present disclosure, moisture can be uniformly frozen over the entire area of the indoor heat exchanger 108, and foreign substances can be uniformly removed over the entire area of the indoor heat exchanger 108.

In addition, according to at least one embodiment of the present disclosure, by repeating the operation of removing foreign substances adsorbed on the indoor heat exchanger 108 according to the amount of moisture contained in the indoor air, the foreign substances adsorbed on the indoor heat exchanger 108 can be removed more effectively.

1.-20. (canceled)

21. A method for operating an air conditioner including a compressor for compressing and discharging a refrigerant, and an indoor heat exchanger for heat exchange between the refrigerant and indoor air, the method comprising:
accumulating a contamination index of the indoor heat exchanger; and
comparing the accumulated contamination index with a first reference contamination index,
wherein, when the accumulated contamination index is equal to or greater than the first reference contamination index, perform a heat exchanger cleaning process.

22. The method for operating an air conditioner of claim 21, wherein, when the accumulated contamination index is less than the first reference contamination index, returning to the accumulating the contamination index of the indoor heat exchanger.

23. The method for operating an air conditioner of claim 21, wherein, when the accumulated contamination index is equal to or greater than the first reference contamination index, prior to the heat exchanger cleaning process, determining whether the heat exchanger cleaning process satisfies a condition in which the process can be performed, and
wherein, when the heat exchanger cleaning process satisfies the condition in which the process can be performed, performing the heat exchanger cleaning process.

24. The method for operating an air conditioner of claim 23, wherein the determining whether the heat exchanger cleaning process satisfies the condition in which the process can be performed determines whether an indoor temperature of a space in which the indoor heat exchanger is located and an outdoor temperature outside the space are within a reference temperature range.

25. The method for operating an air conditioner of claim 21, wherein, when the accumulated contamination index is equal to or greater than the first reference contamination index, prior to the heat exchanger cleaning process, determining whether the heat exchanger cleaning process satisfies a condition in which the process can be performed, and
wherein, when the heat exchanger cleaning process does not satisfy the condition in which the process can be performed, returning to the accumulating the contamination index of the indoor heat exchanger.

26. The method for operating an air conditioner of claim 21, wherein, when the accumulated contamination index is equal to or greater than the first reference contamination index, determining whether the heat exchanger cleaning process satisfies a condition in which the process can be performed,
wherein, when the heat exchanger cleaning process does not satisfy the condition in which the process can be performed, comparing the accumulated contamination index with a second reference contamination index,
wherein, in the comparing the accumulated contamination index with the second reference contamination index, when the accumulated contamination index is equal to or greater than the second reference contamination index, performing a cleaning service recommendation notification to inform a user of a situation where a cleaning service is required, and, when the accumulated contamination index is less than the second reference contamination index, returning to the accumulating the contamination index of the indoor heat exchanger.

27. The method for operating an air conditioner of claim 21, wherein, when the accumulated contamination index is equal to or greater than the first reference contamination index, performing a cleaning notification to notify a user of a situation where the heat exchanger cleaning process is required.

28. The method for operating an air conditioner of claim 27, wherein, in the cleaning notification, indicating on a display part provided in the air conditioner that the heat exchanger cleaning process is required, and indicating on a user's remote device that the heat exchanger cleaning process is required.

29. The method for operating an air conditioner of claim 21, wherein, when the heat exchanger cleaning process is terminated, determining whether the heat exchanger cleaning process is completed, and
wherein, when the heat exchanger cleaning process is completed and terminated, initializing the accumulated contamination index.

30. The method for operating an air conditioner of claim 21, wherein, when the heat exchanger cleaning process is terminated, determining whether the heat exchanger cleaning process is completed, and
wherein, when the heat exchanger cleaning process is terminated without being completed, return to the comparing the accumulated contamination index with the first reference contamination index.

31. The method for operating an air conditioner of claim 21, wherein the heat exchanger cleaning process includes:
condensing water on a surface of the indoor heat exchanger;
freezing the condensed water; and
drying the surface of the indoor heat exchanger.

32. The method for operating an air conditioner of claim 21, further comprising obtaining the contamination index through machine learning using a contamination level data of the indoor heat exchanger as big data.

33. The method for operating an air conditioner of claim 32, further comprising calculating the contamination level data of the indoor heat exchanger using indoor humidity and a temperature of the indoor heat exchanger as factors.

34. The method for operating an air conditioner of claim 21, further comprising updating the contamination index by receiving data from a management server.

35. The method for operating an air conditioner of claim 21, further comprising defining the accumulated contamination index as a contamination level and outputting the contamination level to a display part of the air conditioner or a user's remote device.

36. An air conditioner comprising:
a memory configured to store data; and
a processor configured to control:
a heat exchanger cleaning process for cleaning an indoor heat exchanger;
accumulate a contamination index of the indoor heat exchanger; and
compare the accumulated contamination index with a first reference contamination index,
wherein, when the accumulated contamination index is equal to or greater than the first reference contamination index, the processor is further configured to initiate the heat exchanger cleaning process.

37. The air conditioner of claim 36, wherein the processor is further configured to, when the accumulated contamination index is equal to or greater than the first reference contamination index, prior to the heat exchanger cleaning process, determine whether the heat exchanger cleaning process satisfies a condition in which the process can be performed, and
wherein the processor is further configured to, when the heat exchanger cleaning process satisfies the condition in which the heat exchanger cleaning process can be performed, initiate the heat exchanger cleaning process.

38. The air conditioner of claim 37, wherein the determining whether the heat exchanger cleaning process satisfies the condition in which the process can be performed determines whether the indoor temperature of the space in which the indoor heat exchanger is located and the outdoor temperature outside the space are within a reference temperature range.

39. The air conditioner of claim 36, wherein the processor is further configured to, when the accumulated contamination index is equal to or greater than the first reference contamination index, prior to the heat exchanger cleaning process, determine whether the heat exchanger cleaning process satisfies a condition in which the process can be performed, and
wherein the processor is further configured to, when the heat exchanger cleaning process does not satisfy the condition in which the process can be performed, return to the accumulating the contamination index of the indoor heat exchanger.

40. The air conditioner of claim 36, wherein the processor is further configured to, when the accumulated contamination index is equal to or greater than the first reference contamination index, prior to the heat exchanger cleaning process, determine whether the heat exchanger cleaning process satisfies a condition in which the process can be performed,
wherein the processor is further configured to, when the heat exchanger cleaning process does not satisfy the condition in which the process can be performed, compare the accumulated contamination index with a second reference contamination index, and
wherein, the processor is further configured to, in the comparing the accumulated contamination index with the second reference contamination index, when the accumulated contamination index is equal to or greater than the second reference contamination index, perform a heat exchanger cleaning process recommendation notification to notify the user of a situation where the heat exchanger cleaning process is required, and when the accumulated contamination index is less than the second reference contamination index, return to the accumulating the contamination index of the indoor heat exchanger.
